(19) United States
(12) Patent Application Publication
(10) Pub. No.: US 2009/0172248 A1
(43) Pub. Date: Jul. 2, 2009

(54) MANAGEMENT OF A FLASH MEMORY DEVICE

(76) Inventor: Guangqing You, Shanghai (CN)

Correspondence Address: Barnes & Thornburg, LLP, c/o CPA Global, P.O. Box 52050, Minneapolis, MN, 55402, US

(21) Appl. No.: 11/965,044

(22) Filed: Dec. 27, 2007

(51) Int. Cl. G06F 12/02

(52) U.S. Cl. 711/103; 711/E12.008

(57) ABSTRACT

Methods, computing devices and machine readable medium to manage sector based file system accesses to block erasable flash memory devices are disclosed. One disclosed method includes allocating erasable blocks of a flash memory device to a volume and formatting the volume of a flash memory device with a file system designed to access the flash memory device via sectors that are each smaller than an erasable block. The method also includes writing a data unit to a special block of the erasable blocks and writing a sector mapping table unit to the special block to associate the data unit with a sector of the file system. The method further includes allocating a spare block of erasable blocks to support a reclaim process.

### BACKGROUND

Flash memory devices typically support byte level reads and writes. However, once data has been written to a location of the flash memory device, the location generally must be erased before new data may be written to the location. Many file systems such as the FAT (file allocation table) file system were originally designed for re-writable media (e.g. hard disks), and do not formally delete or erase sectors when a file or directory is deleted. To support the use of such file systems on flash memory devices, volumes have been created that include one or more data blocks, one or more metadata blocks, and one spare block. The data blocks are used to store data, and the metadata blocks are used to store a sector mapping table (SMT) that maps logical sectors of a file system to physical locations of the data blocks. The spare block is used to support a reclaim process. The reclaim process selects a data block having a threshold amount of dirty blocks (e.g. blocks corresponding to overwritten or erased data), copies valid data of the selected block to the spare block, and then erases the selected data block in order to reclaim space of the flash memory device.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a computing device that includes a flash memory device.

FIG. 2 shows an embodiment of a flash sector manager to manage volumes of the flash memory of the computing device.

FIGS. 3A-3C show embodiments of data blocks, metadata blocks, special block, and spare blocks of a volume managed by the flash sector manager.

FIG. 4 shows an embodiment of a management process of the flash sector manger.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

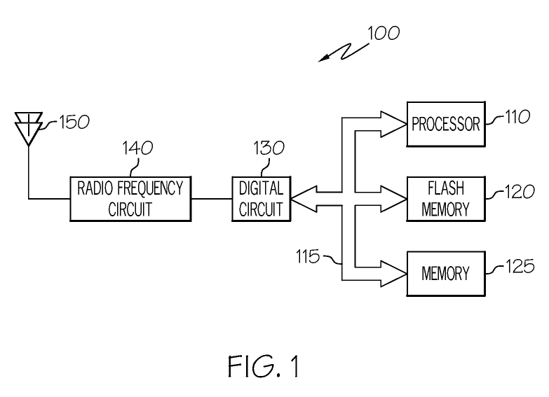

FIG. 1 shows an embodiment of a computing device 100 such as, for example, a cellular phone, a personal digital assistant, a wireless local area network interfaces, or any other suitable system. Other embodiments of the computing device 100 may include a desktop computer system, laptop computer system, server computer system, a network bridge or router, or any other system with or without an antenna. The computing device 100 may include a processor 110, a flash memory device 120, memory 125, a digital circuit 130, a radio frequency (RF) circuit 140, and antennas 150. The processor 110 may include any type of processor adapted to access flash memory device 120 and memory 125. For example, in some embodiments, the processor 110 may include a microprocessor, a digital signal processor, a microcontroller, or the like.

The flash memory device 120 may store information for computing device 100. For example, the flash memory device 120 may store device configuration data, such as contact information with phone numbers, or settings for digital circuit 130 or RF circuit 140. Further, the flash memory device 120 may store multimedia files such as photographs or music files. Still further, the flash memory device 120 may store program code to be executed by processor 110. In some embodiments, the flash memory device 120 may include NOR-type flash memory cells, and in other embodiments, the flash memory device 120 may include NAND-type flash memory cells. The memory cells in the flash memory device 120 may store one data bit per cell, or memory cells may be multilevel cells (MLC) capable of storing more than one bit per cell.

The radio frequency circuit 140 may communicate with antennas 150 and digital circuit 130. In some embodiments, the RF circuit 140 may include a physical interface (PHY) corresponding to a communications protocol. For example, the RF circuit 140 may include modulators, demodulators, mixers, frequency synthesizers, low noise amplifiers, power amplifiers, and the like. In some embodiments, the RF circuit 140 may include a heterodyne receiver, and in other embodiments, the RF circuit 140 may include a direct conversion receiver. In some embodiments, the RF circuit 140 may include multiple receivers. For example, in embodiments with multiple antennas 150, each antenna may be coupled to a corresponding receiver. In operation, the RF circuit 140 may receive communications signals from antennas 150, and may provide signals to the digital circuit 130. Further, the digital circuit 130 may provide signals to the RF circuit 140, which may operate on the signals and then may transmit them to antennas 150.

The digital circuit 130 is coupled to communicate with the processor 110 and the RF circuit 140. In some embodiments, the digital circuit 130 may include circuitry to perform error detection/correction, interleaving, coding/decoding, or the like. Also in some embodiments, the digital circuit 130 may implement all or a portion of a media access control (MAC) layer of a communications protocol. In some embodiments, a MAC layer implementation may be distributed between the processor 110 and the digital circuit 130.

The radio frequency circuit 140 may be adapted to receive and demodulate signals of various formats and at various frequencies. For example, the RF circuit 140 may be adapted to receive time domain multiple access (TDMA) signals, code domain multiple access (CDMA) signals, global system for mobile communications (GSM) signals, orthogonal frequency division multiplexing (OFDM) signals, multiple-input-multiple-output (MIMO) signals, spatial-division multiple access (SDMA) signals, or any other type of communications signals.

The antennas 150 may include one or more antennas. For example, the antennas 150 may include a single directional antenna or an omni-directional antenna having a substantially uniform pattern in at least one plane. For example, in some embodiments, the antennas 150 may include a single omni-directional antenna such as a dipole antenna, or a quarter wave antenna. Also for example, in some embodiments, the antennas 150 may include a single directional antenna such as a parabolic dish antenna or a Yagi antenna. In still further embodiments, the antennas 150 may include multiple physical antennas. For example, in some embodiments, multiple antennas are utilized to support multiple-input-multiple-output (MIMO) processing or spatial-division multiple access (SDMA) processing.

The memory 125 represents an article that includes a machine readable medium. For example, the memory 125 may represent a random access memory (RAM), dynamic random access memory (DRAM), static random access memory (SRAM), read only memory (ROM), flash memory, or any other type of article that includes a medium readable by processor 110. The memory 125 may store instructions that in response to being executed by the processor 110 may result in the computing device 100 performing actions. In operation, the processor 110 may read instructions and data from either or both of flash memory device 120 and memory 125 and performs actions in response thereto. In some embodiments, the flash memory device 120 and the memory 125 are combined into a single memory device. For example, the flash memory device 120 and the memory 125 may both be included in a single flash memory device.

Although various elements of computing device 100 are shown separate in FIG. 1, embodiments exist that combine the circuitry of processor 110, the flash memory device 120, the memory 125 and the digital circuit 130 in a single integrated circuit. For example, the memory 125 or the flash memory device 120 may be an internal memory within the processor 110 or may be a microprogram control store within the processor 110. In some embodiments, the various elements of computing device 100 may be separately packaged and mounted on a common circuit board. In other embodiments, the various elements are separate integrated circuit dies packaged together, such as in a multi-chip module, and in still further embodiments, various elements are on the same integrated circuit die.

The interconnection 115 between the processor 110 and the flash memory device 120 may be implemented using various interconnect technologies. For example, the interconnection 115 may be a serial interface, a test interface, a parallel interface, chipset and/or any other type of interface capable of transferring command and status information between the processor 110, the flash memory device 120, and the memory 125.

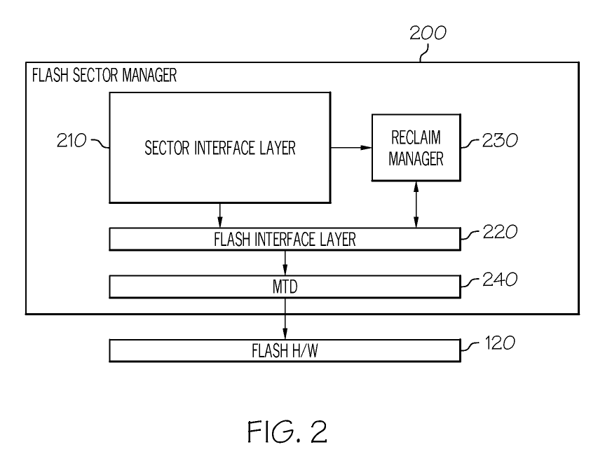

Referring now to FIG. 2, a flash sector manager 200 is shown. In one embodiment, the flash sector manager 200 comprises software modules which may be executed by the processor 110 to manage multiple data volumes of the flash memory device 120. The flash sector manager 200 permits an operating system, user applications, and other software of the computing device 100 to access the flash memory device 120 as a sector addressable medium having multiple volumes in a manner similar to a hard disk drive or floppy disk to which data may be read, written, and/or erased at a sector level having relatively small size (e.g. 512 bytes). In one embodiment, the flash memory device 120 comprises a NOR flash device in which data may only be erased in substantial size blocks (e.g. 256 kilobytes), but in which data may be read, written, and/or invalidated in smaller units (e.g. 1 kilobyte). Since many operating systems and applications are already developed to utilize sector addressable medium such has hard disk drives, the flash sector manager 200 may provide an interface between the sector-level interfaces expect by such software and the physical blocks of the flash memory device 120.

To this end, the flash sector manager 200 may include a sector interface layer 210, a flash interface layer 220, a reclaim manager 230, and a memory technology driver (MTD) 240. The memory technology driver (MTD) 240 may provide a low-level interface for directly manipulating the flash memory device 120. In one embodiment, all accesses to the flash memory device 120 pass through the MTD 240 to ensure system integrity. The MTD 240 may handle flash read, write, erase, unlock, lock, lock-down, and read lock status operations on flash memory device 120. The MTD 240 may identify target flash type upon initialization by reading flash CFI (Common Flash Interface) data.

The flash interface layer 220 may provide upper layers with a logical unit interface and a physical block interface. The flash interface layer 220 may serve unit read/write requests and block read/write/erase requests from upper layers such as the sector interface layer 210 and the reclaim manager 230. In particular, the flash interface layer 220 may call corresponding functions of the memory technology device driver (MTD) 240 to effect the requested unit read/write request and/or block read/write/erase request.

The sector interface layer 210 may maintain a mapping between logical sectors and their physical location of the flash memory device 120. In one embodiment, a block (e.g. 128 kilobytes) of the flash memory device 120 is much larger than a sector (e.g. 512 bytes). As a result, erasing one block of the flash memory device 120 takes a considerable amount of time. In light of the time required to erase a block, storing data at the exact logical block address (LBA) would be very inefficient. The sector interface layer 210 may provide a mechanism to associate logical sector addresses of a file system to corresponding physical locations of the flash memory device 120. In particular, the sector interface layer 210 may maintain such mappings via a data structure called a sector mapping table (SMT) that is stored on the flash memory device 120 in order to maintain such mappings between power cycles of the computing device 100.

The sector interface layer 210 may further include file system snooping. Many file systems such as the FAT (file allocation table) file system were originally designed for re-writable media (e.g. hard disks), and do not formally delete sectors when a file or directory is deleted. However, flash memory device 120 is not re-writable in the same sense as a hard disk. In particular, once a value is written to a location of the flash memory device 120, the location is erased before another value is written to the location. While the flash memory device 120 may support reads and writes at a byte level, the flash memory device 120 commonly only supports erasing at a block level (e.g. 256 kilobytes). Accordingly, the sector interface layer 210 may mark corresponding sectors of the flash memory device 120 as invalid or dirty instead of erasing the corresponding block. As invalid sectors accumulate, a reclaim threshold is reached which may cause the reclaim manager 230 to reclaim dirty space of the flash memory device 120.

The reclaim manager 230 may handle both background reclaim and foreground reclaim to clean up flash dirty space. The reclaim process cleans up the flash media device 120 by retrieving free space from the dirty space generated by sector overwrite/delete operations. In particular, a block in each volume is kept aside as a spare block for purposes of reclaim. The reclaim process may copy all valid data from a reclaim block to the spare block, then erase the reclaim block, thus resulting in the reclaim block becoming the spare block for the volume.

Furthermore, the reclaim manager 230 may provide wear-leveling to enhance reliability and extend the lifetime of the flash memory device 120. Wear-leveling may spread erase counts evenly among physical block of the flash memory device 120. Typically, the write/erase cycle limit of a flash block is 100,000 times. With certain usage models, some types of data may be updated much more frequently than other data. Frequently updated data may tend to become isolated to a few blocks without wear-leveling, thus causing highly cycled blocks to reach their 100,000 erase count limit prior to the product's lifetime stated in specifications. Wear-leveling decreases the possibility of this situation by keeping the maximum erase count difference between any two blocks below a pre-configured limit. In particular, the reclaim process may take the erase count into consideration when identifying a block to reclaim thus favoring a block with a lower erase count.

At initialization, the reclaim manager 230 may create a low priority task that runs a background reclaim process. Execution of the background reclaim process may be controlled by a reclaim trigger semaphore which the sector interface layer 210 may release whenever a fragment of the flash memory device 120 is marked from valid to invalid. In response to the sector interface layer 210 releasing the semaphore, the background process of the reclaim manager may scan the blocks of the flash memory device 120 to check whether a reclaim threshold is reached and may chose to reclaim a block of the flash memory device 120 if the reclaim threshold is reached.

The reclaim manager 230 may further support a foreground reclaim function that may be directly called by the sector interface layer 210 to initiate a reclaim process. In particular, the sector interface layer 210 may initiate the reclaim process to free up some dirty space to allow a foreground operation to continue. In such a situation, the reclaim manager 230 may reclaim the dirties block of the flash memory device 120. The reclaim manager 230 may call functions of the flash interface layer 220 to copy valid logical units to a spare block of the flash memory device 120.

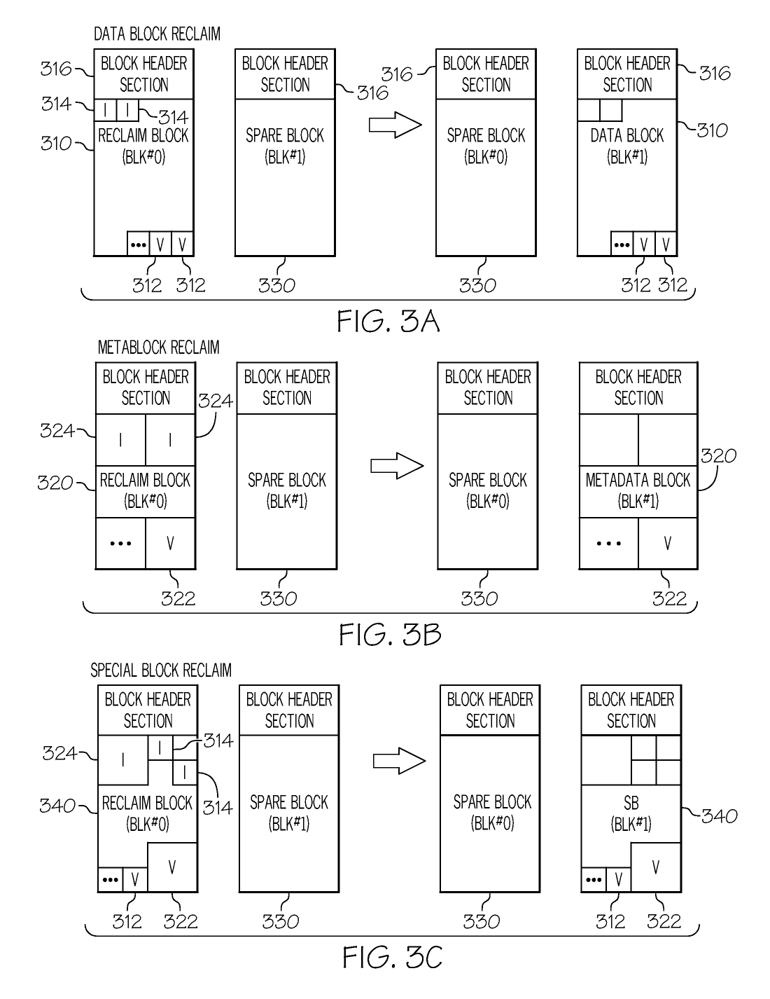

Referring now to FIGS. 3A-3B, a volume of the flash memory device 120 may be implemented with data blocks 310, metadata blocks 320, spare blocks 330, and special blocks 340. As shown, each data block 310, 320, 330, 340 includes a block header 316 that may contain information about respective block and its units. For example, the block header 316 may indicate the type of block (e.g. data, metadata, spare, special) and may indicate whether various units of the block are valid or invalid. Furthermore, the data blocks 310 may store both valid data units 312 and invalid or dirty data units 314. The metadata blocks 320 may store both valid Sector Mapping Table (SMT) units 322 and invalid or dirty SMT units. The special block 340 may store both valid and invalid data units 312, 314 as well as both valid and invalid SMT units 322, 324. The spare block 330 as discussed above may support the reclaim process by providing a location to which valid data and/or valid metadata of a reclaim block may be copied before erasing the selected reclaim block.

In one embodiment, each block 310, 320, 330, 340 of the flash memory device 120 has a size of 128 KB (kilobytes). Moreover, each data block 310 comprises 127 data units 312, 314 that each has a size of 1 KB. Further, each metadata block 320 comprises 63 SMT units 322, 324 that each has a size of 2 KB. Furthermore, each SMT unit 322 includes up to 128 SMT entries thus providing an entry for each data unit 312, 314 of a data block 310. Thus, in one embodiment, a single SMT unit 322 provides mappings for every valid data unit 312 of a corresponding data block 310, and each SMT block 320 provides mappings for up to 63 data blocks 310. It should be appreciated that the above is provided merely for illustrative purposes and that other embodiments may comprise blocks of different sizes and/or SMT units having a different number of entries.

In one embodiment, the volume may comprise a single spare block 330 and a single special block 340; however, it should be appreciated that other combinations of blocks 310, 320, 330 and 340 are also contemplated. In one embodiment, the flash sector manager 210 may determine based upon the size of the volume and flash memory device blocks whether to introduce a special block 340 into the volume in order to reduce overhead of the volume. If the volume includes a spare block 330, one or more data blocks 310, and one or more metadata blocks 320, the volume may include an unusable or mostly unusable empty blocks due the need for SMT units 322 to map data units 312 to logical sectors of a file system. Using such a block as an metadata block 320 may result in more SMT units 322 than needed to map the data units 312 of the volume. Similarly, using such a block as a data block 310 may result in unusable data units 312 due to a lack of SMT units 322 to map the added data units 312 to sectors of the file system. To overcome this limitation and increase the effective storage of the volume, the flash sector manager 210 may use a special block 340 that permits the storage of both data units 312 and SMT units 322, thus reducing overhead associated with the volume.

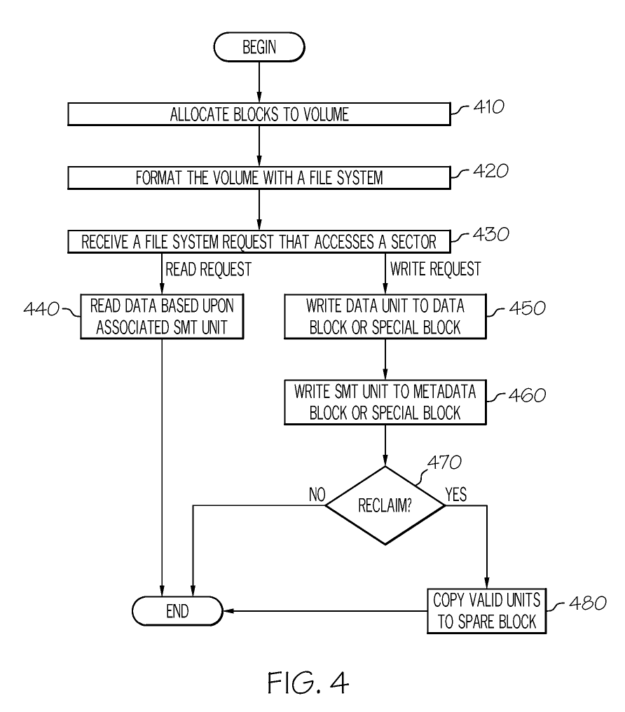

Referring now to FIG. 4, an embodiment of a process to manage file system access to the flash memory device 120 is shown. At 410, the flash sector manager 200 may allocate erasable blocks of the flash memory device 120 to a volume. In particular, the flash sector manager 200 may select blocks of the flash memory device 120 that have not already been allocated to a volume and may designate some of the selected blocks as data blocks 310 to store data units 312, some of the selected blocks as metadata blocks 320 to store SMT units 322, one of the selected blocks as a spare block 330 to support a reclaim process, and potentially one of the selected blocks as a special block 340 to store both data units 312 and SMT units 322. It should be appreciated that the number of blocks selected and the distribution of the blocks as data blocks, metadata blocks, and special blocks depends upon the geometry of the flash memory device (e.g. block size, number of blocks, etc.) as well as the geometry of the volume (e.g. data unit size, SMT unit size, etc.)

Accordingly, a volume may contain a single data block 310, a single metadata block 320, a single spare block 330, and no special block 340. Another volume may contain no data blocks 310, no metadata blocks 320, a single spare block 330, and a single special block 340. Yet another volume may contain multiple data blocks 310, multiple metadata blocks 320, a single spare block 330, and a single special block 340. Generally, the flash sector manager 200 selects the distribution of blocks to maximize the number of data units 312 in the volume while retaining a spare block and enough space for the corresponding SMT units 322. A special block 340 that stores both data units 312 and SMT units 322 provides the flash sector manager 200 with additional flexibility and for some volume sizes enables the flash sector manager 200 to define a volume with more data units 312 than the flash sector manager 200 could define without a special block 340. However, the flash sector manager 200 may not define a special block 340 for all volumes since some volumes may not benefit from a special block 340 or may not benefit enough to justify the additional processing overhead associated with managing the special block 340.

At 420, the flash sector manager 200 may format the defined volume with a file system to permit reading and writing data to the volume of the flash memory device 120 via sectors (e.g. 512 bytes). In one embodiment, the flash sector manager 200 may format the volume using a FAT (file allocation table) file system format such as FAT 12, FAT16 or FAT32 thus storing a file allocation table and boot record to the volume of the flash memory device 120.

The flash sector manager 200 at 430 may receive file system requests which access data for the volume via sectors. In particular, the sector interface layer 210 may receive a read request that attempts to read data from a sector of the file system. In response to receiving the read request, the sector interface layer 210 at 440 may identify the data unit 312 of the read request based upon sector to data unit mappings of the SMT units 322, and may read the requested data from the identified data unit 312. It should be appreciated that the data unit 312 may be part of a data block 310 or a special block 340.

Similarly, the sector interface layer 210 may receive a write request that attempts to write data to a sector of the file system. In response to receiving such a write request, the sector interface layer 210 at 450 may identify the data unit 312 of the request based upon sector to data unit mappings of the SMT units 322, and write the data to the identified data unit 312. Again, the identified data unit 312 may be part of a data block 310 or a special block 340. If the corresponding bytes of the data unit 312 have already been written, the sector interface layer 210 at 450 may instead merge the data of the identified data unit 312 with the data of the write request and write the data to another data unit 312 of the volume which again may be part of a data block 310 or a special block 340. Furthermore, at 460 the sector interface layer 210 may invalidate the identified data unit 312 and its corresponding SMT unit 322 and may write a SMT unit 322 to the volume in order to associate the written data unit 312 with the sector of the file system request. The invalidated data unit 312 may be part of a data block 310 or a special block 340, the invalidated SMT unit 322 may be part of a metadata block 320 or a special block 340, and the newly written SMT unit 322 may be part of a metadata block 320 or a special block 340.

At 470, the reclaim manager 240 of the flash sector manager 200 may determine whether to reclaim a block 310, 320, 340 of the volume. As mentioned above, the reclaim process may be a background process and/or a foreground process. The background process may result in the reclaim manager 240 reclaiming a block of the volume if a dirty space percentage has exceeded a threshold level of dirty. The foreground process may result in the reclaim manager 240 reclaiming a block of the volume regardless of the dirty space percentage. In either case, the reclaim manager 240 at 480 may select a block 310, 320, 340 as a reclaim block, may copy valid units of the selected reclaim block to the spare block 330 without copying invalid units of the selected reclaim block, and may erase the selected reclaim block thus freeing space associated with invalid units. In one embodiment, the reclaim manager 240 selects the dirtiest block 310, 320, 340 as the reclaim block; however, other criteria such as the erase count of a block 310, 320, 340 may also be considered in order to implement wear-leveling.

If the reclaim block is a data block 310, then the reclaim manager 240 copies valid data units 312 to the spare block 330 thus making the spare block 330 a data block 310 and erases the reclaimed data block 310 thus making the reclaimed data block 310 a spare block 330. If the reclaim block is a metadata block 320, then the reclaim manager 240 copies valid SMT units 322 to the spare block 330 thus making the spare block 330 a metadata block 320 and erases the reclaimed metadata block 320 thus making the reclaimed metadata block 320 a spare block 330. Further, if the reclaim block is a special block 340, then the reclaim manager 240 copies valid data units 312 and valid SMT units 322 to the spare block 330 thus making the spare block 330 a special block 340 and erases the reclaimed special block 340 thus making the reclaimed special block 340 a spare block 330.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A method, comprising
allocating a plurality of erasable blocks of a flash memory device to a volume,
formatting the volume of the flash memory device with a file system designed to access the flash memory device via sectors that are each smaller than an erasable block of the plurality of erasable blocks,
allocating a spare block of the plurality of erasable blocks to support a reclaim process,
writing a data unit to a special block of the plurality of erasable blocks, and
writing a sector mapping table unit to the special block of the plurality of erasable blocks to associate the data unit with a sector of the file system.

2. The method of claim 1, further comprising
writing another data unit to a data block of the plurality of erasable blocks, and
writing another sector mapping table unit to the special block to associate the another data unit with another sector of the file system.

3. The method of claim 1, further comprising
writing another data unit to the special block of the plurality of erasable blocks, and
writing another sector mapping table unit to a metadata block of the plurality of erasable blocks to associate the another data unit with another sector of the file system.

4. The method of claim 1, further comprising
writing another data unit to a data block of the plurality of erasable blocks, and
writing another sector mapping table unit to a metadata block of the plurality of erasable blocks to associate the another data unit with another sector of the file system.

5. The method of claim 1, further comprising in response to determining to reclaim dirty space of the special block,
copying valid units but not invalid units from the special block to the spare block to create a new special block comprising the valid units but not the invalid units of the special block, and
erasing the special block after copying the valid units to create a new spare block.

6. The method of claim 5, wherein copying valid units comprises
copying valid data units from the special block to the spare block, and
copying valid sector mapping table units from the special block to the spare block.

7. The method of claim 1, further comprising in response to a request to write new data to the sector associated with the data unit,
invalidating the data unit and its corresponding sector management unit,
writing another data unit to the special block based upon the new data for the sector, and
writing another sector mapping table unit to the special block to associate the another data unit with the sector.

8. A machine readable medium comprising a plurality of instructions that, in response to being executed, result in a computing device
allocating a plurality of erasable blocks of a flash memory device to a volume,
formatting the volume of a flash memory device with a file system designed to access the flash memory device via sectors that are each smaller than an erasable block of the plurality of erasable blocks,
allocating a spare block of the plurality of erasable blocks to support a reclaim process,
writing a data unit to a special block of the plurality of erasable blocks, and
writing a sector mapping table unit to the special block of the plurality of erasable blocks to associate the data unit with a sector of the file system.

9. The machine readable medium of claim 8 wherein the plurality of instructions, in response to being executed, further result in the computing device
writing another data unit to a data block of the plurality of erasable blocks, and
writing another sector mapping table unit to the special block to associate the another data unit with another sector of the file system.

10. The machine readable medium of claim 8 wherein the plurality of instructions, in response to being executed, further result in the computing device
writing another data unit to the special block of the plurality of erasable blocks, and
writing another sector mapping table unit to a metadata block of the plurality of erasable blocks to associate the another data unit with another sector of the file system.

11. The machine readable medium of claim 8 wherein the plurality of instructions, in response to being executed, further result in the computing device
writing another data unit to a data block of the plurality of erasable blocks, and
writing another sector mapping table unit to a metadata block of the plurality of erasable blocks to associate the another data unit with another sector of the file system.

12. The machine readable medium of claim 8 wherein the plurality of instructions, in response to being executed, further result in the computing device
determining to reclaim dirty space of the special block,
copying valid units but not invalid units from the special block to the spare block to create a new special block comprising the valid units but not the invalid units of the special block, and
erasing the special block after copying the valid units to create a new spare block.

13. The machine readable medium of claim 12 wherein copying valid units in response to executing the plurality of instructions, further results in the computing device
copying valid data units from the special block to the spare block, and
copying valid sector mapping table units from the special block to the spare block.

14. The machine readable medium of claim 8 wherein the plurality of instructions, in response to being executed, further result in the computing device in response to a request to write new data to the sector associated with the data unit,
invalidating the data unit and its corresponding sector management unit,
writing another data unit to the special block based upon the new data for the sector, and
writing another sector mapping table unit to the special block to associate the another data unit with the sector.

15. A computing device comprising
a flash memory device comprising a plurality of erasable blocks,
a flash sector manager to manage a volume of the non-volatile memory device that comprises a special block and spare block of the plurality of erasable blocks, and
a processor to execute the flash sector manager in order to write a data unit to a special block of the volume in response to a request to write data to a sector of a file system associated with the volume, to write a sector mapping table unit to the special block to associate the data unit with the sector of the file system, and to reclaim dirty space of the volume via the spare block.

16. The computing device of claim 15 wherein
the volume further comprises a data block of the plurality of erasable blocks, and
the processor is to execute the flash sector manager in order to write another data unit to the data block of the volume in response to a request to write data to another sector of the file system, and to write another sector mapping table unit to the special block of the volume to associate the another data unit with the another sector of the file system.

17. The computing device of claim 15 wherein
the volume further comprises a metadata block of the plurality of erasable blocks, and
the processor is to execute the flash sector manager in order to write another data unit to the special block of the plurality of erasable blocks in response to a request to write data to another sector of the file system, and to write another sector mapping table unit to the metadata block to associate the another data unit with the another sector of the file system.

18. The computing device of claim 15 wherein
the volume further comprises a plurality of data blocks and a plurality of metadata blocks selected from the plurality of erasable blocks of the flash memory device, and
the processor is to execute the flash sector manager in order to write another data unit to a data block of the plurality of data blocks in response to a request to write data to another sector of the file system, and to write another sector mapping table unit to a metadata block of the plurality of metadata blocks to associate the another data unit with the another sector of the file system.

19. The computing device of claim 15 wherein
the volume further comprises a plurality of data blocks and a plurality of metadata blocks selected from the plurality of erasable blocks of the flash memory device, and
the processor is to execute the flash sector manager in order to select a reclaim block from the plurality of data blocks, the plurality of metadata blocks, and the special block, to copy valid units but not invalid units from the selected reclaim block to the spare block of the volume to reclaim space associated with invalid units, and
erasing the selected reclaim block after copying the valid units to create a new spare block.

20. The computing device of claim 19 wherein the processor is to copy valid data units from the selected reclaim block to the spare block, and to copy valid sector mapping table units from the selected reclaim block to the spare block if the selected reclaim block is the special block of the volume.
